(19) United States
(12) Patent Application Publication
(10) Pub. No.: US 2026/0073676 A1
(43) Pub. Date: Mar. 12, 2026

(54) FPGA-BASED SYSTEM AND METHOD FOR DYNAMIC ADJUSTMENT OF A CNN TO IMPROVE DETECTION AND CLASSIFICATION

(71) Applicant: Aliensense Limited, Abu Dhabi (AE)

(72) Inventors: Andrei Rychazhnikov, Abu Dhabi (AE); Alex Lapir, Dubai (AE)

(21) Appl. No.: 18/828,754

(22) Filed: Sep. 9, 2024

(51) Int. Cl. G06V 10/70; G06V 10/764; G06V 10/82; G06V 10/94

(52) U.S. Cl. CPC G06V 10/87; G06V 10/764; G06V 10/82; G06V 10/955

(57) ABSTRACT

Systems and methods for image recognition using computer vision devices with a field-programming gate array (FPGA) and a convolutional neural network (CNN). A first CNN configuration is used for object class detection. Alternative CNN configurations are loaded for precise object classification and identification in real time under FPGA control.

### TECHNICAL FIELD

This invention relates to the field of image processing and machine vision, and more particularly, adjustable convolutional neural networks (CNNs) applied by field-programmable gate array (FPGA) for image processing and machine vision.

### BACKGROUND

Detection and classification capabilities of existing machine vision imaging systems suffer certain limitations. Traditional systems lack flexibility and adaptability, as they often rely on a static CNN model. This results in suboptimal performance when dealing with diverse environments and changing conditions. Traditional systems also face challenges in maintaining accuracy and efficiency. Existing systems need to be restarted, for example, to apply a more efficient and accurate CNN model, particularly in resource-constrained environments. Examples of such environments of machine vision systems include autonomous vehicles and unmanned aerial vehicles (UAVs). Therefore, there is a need for improved CNN model application for image processing and machine vision.

### SUMMARY

A device is disclosed for capturing and classifying a digital image of an object. The device has a flash memory, an image sensor configured for capturing a plurality of image frames of the object, and an image processing module configured to receive the plurality of image frames from the image sensor and to filter, enhance, or scale the plurality of image frames. Also part of the device is a convolutional neural network (CNN) with an adjustable configuration configured for processing the image frames and identifying an object class using a first configuration. A plurality of CNN configurations are stored in the flash memory, each CNN configuration having a set of weights and CNN parameters. The CNN parameters comprise a number of layers, a number of connections inside and between the layers, and a number of input and output channels of every convolutional layer.

The device also includes an FPGA control block, operably connected to the flash memory, the image processing module, and the CNN. The FPGA control block adjusts CNN configurations according to a set of adjustment rules stored in the flash memory in a control registry. The FPGA control block is configured to direct the CNN to determine whether the object is within the object class with a predetermined or greater degree of certainty using the first CNN configuration for a predetermined time period t₁. When the CNN is unable to determine whether the object is within the object class with a predetermined or greater degree of certainty after period t₁ using the first CNN configuration, the CNN is adjusted in accordance with the stored control registry rules by applying a second CNN configuration from the flash memory. The CNN is directed to determine whether the object is within the object class with a predetermined or greater degree of certainty, determine a probability of recognition, and determine a pose estimation and coordinates of the object within the image determined by the CNN using the second configuration of the CNN.

The device is coupled to a transmitter, configured to send a message to a receiver. The message includes at least one of the following parameters: the object class, the probability of recognition, the pose estimation, and the coordinates of the object within the image determined by the CNN.

In alternative embodiments, the transmitted message contains an image with an identified object class and a probability of detection. The predetermined degree of certainty can correspond to an uncertain determination that the object is within the object class. The FPGA control block can be further configured to change CNN configurations and restore the first CNN configuration in accordance with the set of adjustment rules stored in flash memory in the control registry after the object is classified with predetermined or greater degree of certainty using the second configuration. Adjusting the configuration of the CNN can include one or more of modifying the weights, the number of layers, the number of connections inside and between the layers, and the number of input and output channels of every convolutional layer.

A method is also disclosed for capturing and classifying a digital image of an object. A plurality of image frames of the object are captured using an image sensor. The plurality of image frames are filtered, enhanced, or scaled using an image processing module. A flash memory is provided and includes a convolutional neural network (CNN) and a plurality of configurations of the CNN. Each CNN configuration has a set of weights and CNN parameters. The CNN parameters comprise a number of layers, a number of connections inside and between the layers, and a number of input and output channels of the convolutional layer multipliers.

Image frames are processed using the CNN with a first CNN configuration under the control of a Field-Programmable gate array (FPGA) control block to identify an object class, wherein the FPGA control block adjusts CNN configurations according to a set of adjustment rules stored in the flash memory in the control registry. A determination is made whether the object is within the object class with a predetermined or greater degree of certainty for a predetermined time period t₁.

When the CNN is unable to determine whether the object is within the object class with a predetermined degree of certainty after period t₁ using the first CNN configuration, a second CNN configuration is applied from the flash memory. A determination is made whether the object is within the object class with a predetermined degree of certainty using the second CNN configuration. Determinations are also made for a probability of recognition, a pose estimation, and coordinates of the object within the image.

A message is sent to a receiver that includes at least one of the following parameters: the object class, the probability of recognition, the pose estimation, and the coordinates of the object within the image determined by the second CNN.

In alternative embodiments, the second CNN configuration is followed by a third CNN configuration over a time t₃, wherein time t₃ lasts until the CNN is able to determine whether the object is within the object class with a predetermined degree of certainty. The predetermined degree of certainty can correspond to a determination that the object is within an object class. The FPGA control block can be further configured to reapply the first CNN configuration after the object is classified with predetermined or greater degree of certainty using the second CNN configuration.

An alternative method is disclosed for capturing and classifying a digital image of an object. A plurality of image frames of the object are captured using an image sensor positioned at a first location. The plurality of image frames are filtered, enhanced, or scaled using an image processing module at the first location. At the first location, a flash memory is provided and includes a convolutional neural network (CNN) and a plurality of configurations of the CNN. Each CNN configuration has a set of weights and CNN parameters. The CNN parameters in turn have a number of layers, a number of connections inside and between the layers, and a number of input and output channels of the convolutional layer multipliers. Image frames are processed using the CNN with a first CNN configuration under the control of a Field-Programmable gate array (FPGA) control block to identify an object class, wherein the FPGA control block adjusts CNN configurations according to a set of adjustment rules stored in the flash memory in the control registry. A determination is made whether the object is within the object class with a predetermined or greater degree of certainty for a predetermined time period t₁. When the CNN is unable to determine whether the object is within the object class with a predetermined or greater degree of certainty after period t₁ using the first CNN configuration, applying a second CNN configuration from the flash memory. Directed by the FPGA, the CNN determines whether the object is within the object class with the predetermined or greater degree of certainty using the second CNN configuration, to determine a probability of recognition, and to determine a pose estimation and coordinates of the object within the image determined by the second CNN. A message is sent to a second location, remote from the first location. This message includes the object class determined by the second CNN.

In alternative embodiments, the second CNN configuration is followed by a third CNN configuration over a time t₃, wherein time t₃ lasts until the CNN is able to determine whether the object is within the object class with the predetermined or greater degree of certainty. The FPGA control block can be further configured to apply a plurality of CNN configurations with different system requirements and further configured to adjust CNN configurations based on available system resources. The method of claim 10, wherein the FPGA control block is further configured to change remove added CNN configurations and to re-apply the first CNN configuration after the object is classified with predetermined or greater certainty using the second CNN configuration. The predetermined degree of certainty can correspond to a determination that the object is within an object class. Alternatively, the predetermined degree of certainty can correspond to an uncertain determination that the object is within the object class.

In an embodiment, the application of CNN configurations proceeds in both directions. For example, the second CNN configuration is applied after the CNN configuration is applied. The control registry can also include rules for object processing based on environmental conditions at the first location. The rules for object processing can also include a set of predetermined degrees of certainty for different objects, a set of rules whether the message should be sent if the object within specific class has been determined with probability above an uncertain threshold and below a certain threshold or should be sent only if probability of recognition exceeds the certain threshold, and a set of rules should be the object within specific class processed with more accurate CNN if it possible or not. The sent message can include the probability of recognition, the pose estimation, and the coordinates of the object within the image determined by the second CNN. The predetermined degree of certainty is stored in the control registry and can also be adjusted dynamically, for example, based on the urgency of task execution, where the FPGA controls the execution of a plurality of tasks having various urgencies. The second location can be in communication with the first location by a communications network. The image sensor can also be mounted in a fixed position at the first location.

### BRIEF DESCRIPTION OF THE DRAWINGS

FIG. 1 is a block diagram of an FPGA camera device with an onboard CNN, according to an embodiment.

FIG. 2 is a table showing examples of CNN configurations, according to an embodiment.

FIG. 3 is a flowchart for a method of capturing and classifying a digital image, according to an embodiment.

FIG. 4 is a flowchart for an alternative method of capturing and classifying a digital image, according to an embodiment.

The embodiments described are exemplary ways to use the invention to solve technical problems in the field of the invention. The solutions and techniques disclosed can also be used to solve other problems in the field or to solve similar problems in other fields. Substitutions, modifications, and equivalents known to those of skill in the art can be used to implement these solutions and techniques, consistent with scope of the invention described in the claims.

### DETAILED DESCRIPTION

Systems and methods for computer vision include an onboard convolutional neural network (CNN) model executed by a Field Programmable gate array (FPGA), with the ability to dynamically adjust CNN configurations in real-time. Dynamic adjustment of CNN configurations contributes to improved object detection accuracy by the onboard CNN. The system starts by loading a CNN with a lightweight configuration for identifying object classes. As the CNN processes and classifies objects, the CNN's configurations are adjusted in real time under FPGA control. The CNN configuration adjustment allows use of the CNN to perform tasks with more accurate results without restart of the system making dynamic adjustment particularly suitable for devices such as autonomous vehicles and drones. A modular design is used for the FPGA computer vision device to allow continuous updates and improvements to the CNN model without requiring changes to critical hardware components such as memory, processing units, or system architecture. This approach enables the device to adapt its object detection classification and pose estimation capabilities to various scenarios without system restart.

The onboard CNN is a CNN with adjustable configuration optimized in real time for processing images. The CNN balances latency and time of recognition for classification accuracy, adjusting the configuration for processing images without the need for system restarts. This dynamic adjustment allows the CNN to modify its configuration as needed, providing continuous and efficient operation. Classification accuracy is monitored in real time. When classification accuracy drops below a predetermined threshold, the CNN configuration is adjusted according to predetermined rules stored in a control registry, for example, by applying additional weights, changing number of connections inside and between the layers, changing number of input and output channels of every convolutional layer parameters, until the classification accuracy reaches an acceptable level. These configuration parameters are stored in flash memory until needed in the course of dynamic adjustments in accordance with predetermined rules.

In the context of a CNN, weights are the adjustable parameters that enable the network to correlate input data with pre-trained images for accurate predictions. Weights play a key role in the convolutional layers, where they represent the values within the filters or kernels. During convolution operation, each filter is slid across the input, performing element-wise multiplication with the corresponding region and summing the results. This process essentially applies a weighted combination of the input pixels to generate a single value in the output feature map. By adjusting weights during training, the network fine-tunes the filters to improve the correlation between input images and pre-trained patterns, such as edges, corners, or textures, which are required for object recognition or image classification tasks.

Weights are also present in fully connected layers, often found in the final stages of a CNN. Each neuron can be connected to every neuron in the previous layer, and each connection has an associated weight that determines the strength of the signal transmitted between them. These weights enable the network to classify objects by searching for correlations between input image and pre-trained images and make complex decisions such as pose estimation based on the learned patterns.

CNN configurations, including sets of weights, number of layers, connections inside and between layers, and number of input and output channels of every convolutional layer are stored in EEPROM flash memory. These configurations are available for application under control of the FPGA control block.

In an exemplary embodiment, the stored CNN configurations are layered such that the CNN has multiple layers. Of these layers, layer n represents the lightest layer in terms of computational resources required to run the CNN. Inputs and outputs are defined for each element. In the context of CNNs, an element within a layer refers to a single unit or value within the multidimensional arrays that represent the data as it flows through the network. The CNN is made up of various types of layers, including, for example, convolutional layers, concatenation layers, upsample layers, bottleneck layers, pooling layers, and fully connected layers, each performing specific operations on the input data to transform it into a new representation. The data within each layer can be represented as multidimensional arrays (tensors). For example, in the early layers of a CNN processing images, the data might be an array representing the height, width, and color channels of the image. An element is then a single value within these arrays. For instance, an element could be the intensity of the red color channel at a specific pixel location. The operations within each layer, such as convolutions or pooling, act on these elements, combining and transforming them to create new elements in the subsequent layer. This process of transformation allows the network to find the correlation between input data and pre-trained patterns.

In a Convolutional Neural Network (CNN), input and output channels refer to the number of feature maps or activation maps at different stages of the network. Input channels represent the number of feature maps or color channels in the input data. For example, a standard RGB image generates three input channels (red, green, and blue) for the first layer of a CNN. In deeper layers of a CNN, the input channels correspond to the number of feature maps generated by the previous layer. On the other hand, output channels represent the number of feature maps produced by a convolutional layer. Each filter in a convolutional layer generates one output channel. The number of output channels determines the depth of the output volume at that layer.

Generally speaking, input channels provide the initial information to the network, while output channels capture the correlations identified with pre-trained patterns at different levels. The interplay between input and output channels allows the CNN to strengthen the correlation between the input data and pre-trained patterns, providing effective image classification and object detection. For each type of CNN configuration there can be a specific structure comprising a certain number of inputs and outputs for each layer, connections inside and between layers and corresponding set of weights defined after network training.

In an embodiment, a database or table is used to store object classes of interest. A specific CNN configuration can then be applied to specific object classes. In an embodiment, the detection of impossible classifications—a flying cow, for example—is prevented by applying a CNN configuration that more precisely classifies flying objects. The CNN can be trained on different datasets for different configurations. Rules can be established for object classes of interest, based on expected and unusual object classes. For example, when an unusual (but not impossible) object is detected in a roadway, such as a military personnel carrier or a tank, a specific CNN configuration can be loaded to confirm the detection and classify the object.

Exemplary applications of such rules include a configuration where detection of a human body on a road with even a 30% probability will trigger application of another, heavier configuration to confirm the detection. Other configuration probabilities can likewise be used, such as at least 5%, at least 10%, at least 15%, at least 20%, at least 25%, at least 35%, at least 40%, at least 45%, or at least 50%.

In the context CNNs configurations, heavy weights and light weights refer to the number of calculations involved in CNN processing, and the amount of resources which is necessary to perform the calculation with appropriate speed. Due to the hardware limitations such as number of available multipliers, maximum frequencies for memory access and size of available memory, a heavier configuration requires a significantly longer time for processing than a lighter configuration. In return, the heavier configuration allows to successfully determine a larger number of object's classes, more accurately find an object's coordinates within the image and more carefully estimate the pose of the object.

Weights are the core parameters of a CNN, representing the strength of connections between neurons in different layers. Weights determine how much influence each input feature of the pre-trained images has on the output, enabling the network to learn meaningful patterns from the data. Biases, on the other hand, act as additional constants added to each neuron's activation, providing an offset that allows the neuron to fire even when the weighted sum of inputs is zero. This flexibility helps the model learn more complex decision boundaries and prevents it from being overly reliant on the input data alone.

Complexity of the CNN configuration refers to the overall sophistication and capacity of the CNN model. Complexity of the CNN configuration is influenced by factors such as the number of layers, the number of parameters (weights and biases), number of input and output channels, and the type of layers used. Deeper networks with more parameters tend to be more complex, allowing such networks to capture finer details in the data, but which also risk overfitting if not properly regularized.

Biases add flexibility and parameters, contributing to the overall complexity of the CNN configuration. Moreover, complex models with deeper architectures or numerous parameters often require biases to effectively learn from the data and avoid underfitting.

Generally speaking, weights define the core learning mechanism, biases provide flexibility and expressiveness, and complexity reflects the model's capacity and potential for learning intricate patterns.

In an embodiment, the CNN's configuration is adjusted continuously until a specific object can be classified with a predetermined accuracy, such as 90%. Other configuration probabilities can likewise be used, such as at least 50%, at least 55%, at least 60%, at least 65%, at least 70%, at least 75%, at least 80%, at least 85%, or at least 95%. Once the classification is made with the required accuracy, the CNN's configuration can be changed to a lighter configuration, or to the lightest configuration. Thus, the CNN configurations can be applied and changed back in a continuous manner to optimize CNN performance while minimizing the use of system resources such as memory when higher levels of performance are not required for object classification.

In an embodiment, an object is detected by the onboard optical-electrical imaging system. The FPGA module is loaded with its initial firmware, including the CNN with lightweight configuration. In case the CNN with lightweight configuration is unable to classify the object with a predetermined level of certainty, for example, 90% certainty, the FPGA control block causes adjusted parameters to be applied from flash memory and directs the CNN to process the object using the adjusted parameters. Image frames of the object remain loaded in external random access memory (RAM) and thus these image frames are available for processing. If the object still cannot be classified, the FPGA control block applies more adjusted parameters, for example weights, from flash memory and multiplexes (switches) connections inside and between layers. Then the device applies the lightweight configuration and continues classification. Configuration parameters can be applied as necessary based on available system resources or requirements for specific degrees of certainty.

The process of CNN configuration adjustment comprises various operations. In an embodiment, the FPGA computer vision device has an onboard FPGA and multiple sets of CNN configuration in memory, such as flash memory. The stored sets of configurations allow the CNN to identify objects with different degrees of certainty. For example, in some conditions, a lightweight CNN will suffice to classify an object with the required degree of certainty. In other conditions, such as low light, cloudy weather, high amounts of reflection, and so on, achieving the required accuracy can require one or more adjustments to the CNN.

In an embodiment, a default, lightweight CNN configuration is selected for quick object processing, for example, by processing objects with relatively low levels of certainty. Parameter adjustment happens based on a set of adjustment rules, for example, when the CNN with lightweight configuration processes captured image frames to determine an object class but the certainty level is lower than a predetermined threshold. Once the CNN with lightweight configuration has completed its classification, the FPGA determines whether rules are stored governing recognition of objects within the object class determined by the CNN with lightweight configuration. If so, the onboard FPGA applies the required CNN configuration and reconfigures CNN to process the captured image frames, which are already stored in external RAM. After the CNN with adjusted configuration completes its analysis and provides detailed classification results, the system applies another CNN configuration. The next CNN configuration to be applied depends on real-time conditions. When no special cases are present and classification accuracy is above a predetermined threshold, the FPGA can be reconfigured with the lightweight CNN configuration. Alternatively, when the CNN completes its analysis and provides its classification results, the FPGA applies a different CNN configuration. The FPGA can continue the process of applying CNN configurations as long as directed by object-class rules or until a predetermined classification reliability threshold is reached. Accordingly, the CNN configuration can be adjusted both in the direction of heavier and lighter parameters.

The process of adjusting the CNN configuration includes a determination by the FPGA control block that it is time to adjust the CNN model. In an embodiment, a CNN configuration adjustment will occur when the CNN with lightweight configuration has identified the class of object but without the required degree of certainty. When this condition is met, a parameter set will be applied. Alternatively, a parameter applying occurs when a class of object is recognized but the probability of this recognition is below a predetermined threshold. When this condition is met, the CNN is configured to provide a more reliable result. In an alternative embodiment, the FPGA control block can also be configured to process the object even when the processing speed of the image processing module is reduced by adding parameters to the CNN. Such direction by the FPGA control block can be made, for example, for classifications that concern high priority objects, such as emergency vehicles or children.

In an embodiment, the predetermined degree of certainty required for applying additional parameters is adjusted dynamically based on the urgency of task execution, for example, based on factors such as task priority, real-time constraints, or specific accuracy and processing time thresholds. For example, for accurate classification the CNN adjustment threshold can be reduced to make the system more likely to adjust the CNN configuration. When fast classification is needed -such as in time-sensitive operations, the CNN adjustment threshold can be raised to make the system less likely to adjust the CNN configuration.

In an embodiment, the value of the required degree of certainty can be the same across multiple CNN configurations. For example, a first CNN configuration can be configured with a given degree of certainty (e.g. 80%). A second CNN configuration can be configured with the same given degree of certainty (e.g. 80%). Any number of CNN configurations can similarly be configured with the same given degree of certainty (e.g. 80%). In an embodiment, the value of the required degree of certainty can be different for different CNN configurations. For example, a first CNN configuration can be configured with a first degree of certainty (e.g. 50%). A second CNN configuration can be configured with a second degree of certainty different than the first degree of certainty. In an embodiment, the second degree of certainty can be higher (e.g. 75%) or lower (e.g. 45%) than the first degree of certainty. Any number of CNN configurations can be similarly configured with different degrees of certainty from the first degree of certainty and/or the second degree of certainty.

A determination that the object is not clearly within the object class (uncertainty) can result from environmental conditions at a given location. For example, low light conditions, shadows, rain, and fog can contribute to uncertainty in classification. In an embodiment, when available CNN configurations have been applied and there is no classification with the required predetermined degree of certainty for the object, the classification with the highest degree of certainty is selected. This classification, being the most certain available, can be used for sending to a receiver (or to a remote location) the CNN's classification results and related information. In an embodiment, an object can be detected with a classification result below the predetermined degree of certainty (e.g. above 60%), but within a predetermined degree of uncertainty (e.g. between 20% and 60%).

In an alternative embodiment, certain parameters are considered by the FPGA control module before adjusting the CNN configuration. Such parameters can include the type of the object's class, the probability of recognition, or a use-case specific threshold. For example, when an object is in the class “sedan” with a 75% certainty but the system requires a 90% certainty, an adjustment will be made to confirm the classification with the required degree of certainty. Or an adjustment will take place when the probability of recognition by the CNN with lightweight configuration is less than the predetermined threshold, such as below 90% confidence. Alternatively, the adjustment parameter can be set when the probability is above a minimum threshold. A use-case specific parameter can include specific linkages of object class and probabilities. For example, certain classes of objects are linked to an object-specific probability to trigger adjustment while other classes of objects have a different probability required to trigger an adjustment. For example, the class “person” can be linked to a different probability (90%, for example) to trigger an adjustment of the CNN configuration than the class “sedan” (75%, for example).

The processing of images by the FPGA computer vision device starts with image-frame input. An image-frame format is used that is compatible with the CNN trained dataset. For example, the image-frames inputted to the image processing module can include raw images, jpeg files, tiff files, png images, or an image format without interaction with previous or next frames. The images can be monochrome or color. Object determination of a class of object, and determination of specific objects in the class, are both based on calculation of the correlation of the captured image frames with a pre-trained pack of images, typically in the form of a dataset. The weights, number of layers, number of connections inside and between layers, and number of input and output channels of every convolutional layer are configured to detect different objects with a relatively high speed and identify specific objects from among a large number of similar objects. A correlation can also be found with relatively fewer significant visual features of the object. Fine-grained object detection generally requires more time than the “lightweight” CNN's task, where correlations with more prominent visual features are established more quickly. To distinguish a bear from a horse, for example, requires less processing than distinguishing between two bears. Both of these processes, however, include finding a correlation with a dataset of images saved in memory.

Registers within the camera define the FPGA camera settings and neural network configurations parameters. These registers govern various settings, including gain, brightness, region of interest, exposure, white balance, sharpness, contrast, lens position, and high dynamic range (HDR) mode. Registers within the camera also control neural network operations, such as rules, setting thresholds for neural network processing, determining whether the entire image should be compressed before being input into the neural network or processed iteratively using defined windows, and whether switching to a second neural network is permitted. The control registers are stored in flash memory to guarantee that the camera will resume operation in the exact state in which it was previously functioning in the event of a power interruption.

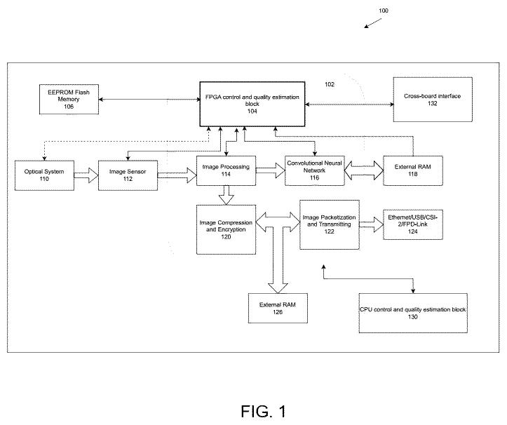

An exemplary system 100 embodying a FPGA computer vision device is shown in FIG. 1. As described with respect to system 100, various modules can include respective sets of program instructions that adapt the module to implement the particular functionality utilizing the hardware of system 100.

FPGA 102 includes control and quality estimation block 104, which is coupled to EEPROM flash memory 106. Images are captured by optical-electrical system 110, which passes the captured images to image sensor 112. Image processing module 114, a subcomponent of FPGA 102, passes the processed images to convolutional neural network (CNN) 116. CNN 116 is coupled to external RAM 118 for image analysis. External RAM 118 generally serves to facilitate CNN classification for images whose large file size requires additional RAM. In an embodiment, blocks refer to fixed, hardware-level building blocks within FPGA 102. Modules refer to flexible structures that can include user-defined collections of logic that utilize the FPGA's resources, including blocks.

In an embodiment, a CNN and a plurality of CNN configurations are stored in the flash memory 106. The hardware used for flash memory 106 is selected to have a capacity sufficient for the onboard CNN and the CNN configurations, which can include multiple sets of weights, CNN adjustment rules (rules with a number of layers), a number of connections inside and between layers and a number of input and output channels of every convolutional layer for adjusting the CNN. For example, the file size of a CNN and the memory used by its weights varies based on the CNN's configuration attributes. CNNs rely on weights within their convolutional filters to identify specific patterns in image data. These weights are iteratively adjusted during training through backpropagation and optimization algorithms, leading to a reduction in classification error. The final set of weights represents the network's learned understanding of visual features, enabling accurate image classification. Deeper neural networks with more layers tend to have larger file sizes and require more memory for weights. Similarly, layers with more neurons (or filters in the case of convolutional layers) have more weights, increasing file size and memory usage. The size of the input data also plays a role. In an embodiment, weights for a pre-trained CNN, for example in the case of YOLO8, require about 3-6 MB of memory. The FPGA structure itself can take up another 10 MB. In such an embodiment, the flash memory required a CNN and several sets of weights is at least 32 MB.

Processed images are also passed for compression and encryption to image compression and encryption module 120. From image compression and encryption module 120, the compressed images are prepared for transmission by passing the compressed images to image packetization and transmission module 122. Image packetization and transmission module 122 transmits the packetized images to remote locations by way of Ethernet/USB/CSI-2/FPD-Link or another high bandwidth interface available to transmit images at a high rate. Packetization divides large image or video data into smaller packets for efficient network transmission, enabling error correction, congestion control, and parallel processing. Compression reduces data size for storage and bandwidth efficiency, sometimes enabling real-time processing. Packetization and compression can be used, for example, for video surveillance and autonomous vehicles where large visual datasets require fast, reliable handling. Compression can be lossy (higher compression, potential quality loss) or lossless (preserves all data, lower compression).

Other interfaces that support high-bandwidth transmission can be used and ideally will allow the operator to receive the image with the similar or faster speeds. Processed images are also passed from image compression and encryption module 120 to external RAM 126. Images can also be loaded from external RAM 126. RAM 126 generally can be used to store results, compressed or encrypted files, and files for transmission.

FPGA 102 is controlled by FPGA control and quality estimation block 104. Probability of detection or recognition is a parameter of an onboard CNN, such as CNN 116. CNN uses a large number of correlation calculations, for example, millions of calculations for every image. The CNN compares a large number of pretrained images, which are known and labeled objects, and the image frames to be processed. If the training process shows a high level of correlation with some class of pre-trained objects in the datasets, the training process increases the probability of recognizing such an object inside the current image. High correlation contributes to increased probability estimation. The probabilities received during some predefined period of time are compared to the thresholds. This comparison allows for the FPGA quality estimation's block to make conclusions about the quality of CNN. In an embodiment, block 104 handles FPGA control and quality estimation. Alternatively, a separate control and quality estimation block 130 is used for estimating quality of CNN classifications and for controlling FPGA 102 operations.

Cross-board interface 132 is used to connect the FPGA control block 104 to external devices. The information shared with external devices can be objects, classes, coordinates, probability of recognition, pose estimation. Cross-board interface 132 can be configured in various ways as a bridge or GPIO (General Purpose Input/Output). GPIO refers to a type of pin on an integrated circuit or electronic circuit board that can be configured by the user to perform different input or output functions. An RS-485 Bridge is a device that allows communication between two or more RS-485 networks. I2C bridges (also known as I2C multiplexers or I2C routers) are devices that allow multiple I2C devices to be connected to a single I2C bus. An SPI bridge is a device that allows communication between two or more Serial Peripheral Interface (SPI) networks or devices. A UART bridge is a device that allows communication between two or more Universal Asynchronous Receiver-Transmitter (UART) networks or devices. Cross-board interface 132, in its various configurations, acts as a translator, enabling data exchange between devices that have different protocols or data formats.

In the realm of CNN-based computer vision, pose estimation involves the precise determination of the spatial location and orientation of key points on objects within images or videos, enabling the understanding of their position and potential movements. CNNs, due to their capacity for learning hierarchical image features, excel at pose estimation, effectively handling variations and occlusions. In the context of traffic monitoring systems, for example, comprehending the pose of vehicles aids in identifying their actions, potentially enabling applications such as automated traffic flow analysis or incident detection. Perceiving the orientation and movements of other vehicles and objects on the road, thereby enhancing safety and facilitating informed decision-making for navigation and collision avoidance.

The cross-board interface 132 can be employed by any external system to share data, including meta-information generated from the image classification process. This meta-information can include details such as the number of objects detected, their classes, and subclasses. For instance, in a traffic light control system, the camera can detect a human approaching the traffic light. A CNN running locally in a lightweight configuration classifies the detected object as a “human” with a 30% certainty. The system has a rule that classifications of objects as “human” must be made with at least 90% certainty. The system applies an adjusted CNN configuration with heavier weights and reassesses the classification. If the classification is below 90%, the process continues with another CNN configuration with even heavier weights. Once classification is made with the required certainty, the classification results are transmitted through the cross-board interface 132 to the traffic light control system. Based on the presence of a human person near the traffic light, the system can automatically switch the light from green to red for cars, ensuring safe crossing.

Another example involves automated parking systems, where the camera detects vehicles entering a parking lot. The system's lightweight CNN identifies the vehicle as an “electric car” with a 90% certainty. In this example, the system's rule for “electric car” classifications requires only 85% certainty and there is no other rule requiring reassessment of the CNN's result. The classification results are sent to the parking management system via the cross-board interface 132, enabling the system to guide the electric vehicle to a designated charging station.

In another example, as part of security surveillance, a camera can monitor the entrance to a restricted area. The system, using a lightweight CNN, identifies an approaching object as an “employee” or an “unauthorized individual” with a 75% certainty. In this example, the system's classification rule requires at least 90% certainty for employees but only 75% certainty for unauthorized individuals. The classification of the unauthorized individual is complete, but the classification of the employee requires at least one CNN adjustment to achieve the 90% minimum certainty. The locally generated classification data is shared with a remote security system through the cross-board interface 132, allowing the system to trigger an alert or lock doors automatically if the individual is unauthorized, or unlock the doors for the employee.

In another practical application, the cross-board interface 132 is utilized in Unmanned Aerial Vehicles (UAVs) for rescue operations and security systems. The UAV can detect an object during a flight and classify it as a “person” with 45% certainty using a lightweight CNN. In this example, the system rules require at least 90% certainty for “persons” and also collects pose information. After the initial classification, the FPGA control block triggers a CNN adjustment to refine the identification process. The adjusted CNN then processes the object further and identifies the person with 95% certainty and further classifies the person as “lying down” or “staying in one place”. This detailed classification is important for rescue missions, as it enables the UAV to relay precise information through the cross-board interface 132 to ground control or emergency services. The meta-information (results of the class identifications) provided allows rescue teams to prioritize their response and take appropriate action based on the specific needs of the identified individual.

The cross-board interface 132 thus functions as a channel for meta-information, which includes the results of the classification process. Classification information is important for controlling external systems, enabling them to make informed decisions based on the detected objects and their classifications. The cross-board interface 132 facilitates the seamless exchange of this meta-information between the FPGA control block and connected external systems, guaranteeing that the systems respond effectively to real-time data.

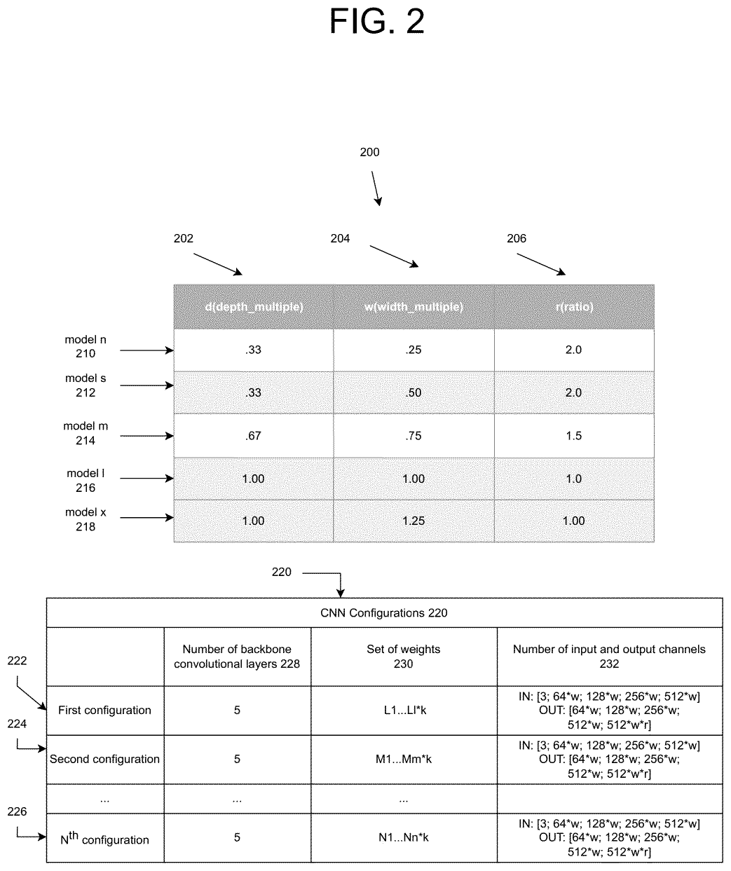

The device of FIG. 1 can be used in connection with the exemplary CNN configurations 200 shown in FIG. 2. The exemplary configuration parameters include depth multiple 202, width multiple 204, and ratio 206. Depth multiple 202 refers to the scaling factor applied to the number of layers in the network and is used to control the network's depth. Width multiple 204 refers to the scaling factor applied to the number of filters or channels in each layer, impacting the width of the network. Ratio 206 is the scaling factor that adjusts the aspect ratio of the input image, affecting the dimensions of the bounding box predictions. Sample values are shown for CNN configurations ranging from model n 210 (the most lightweight) to model x 218 (the most heavyweight), including intermediate model s 212, model m 214, and model l 216. Table 220 provides examples of the CNN configurations, including the number of backbone convolutional layers, sets of weights, and the number of input and output channels corresponding to each configuration. The configurations table can also include additional parameters, such as the number of connections inside and between layers, to further refine the CNN's performance.

An exemplary CNN configurations table 220 shows values for first configuration 222, second configuration 224, up to the N^{th} configuration 226. For each configuration, a number of backbone convolution layers is given in column 228. In column 238, each configuration is assigned a set of weights 230. In column 232, the number of input and output channels is specified for each configuration (224-226).

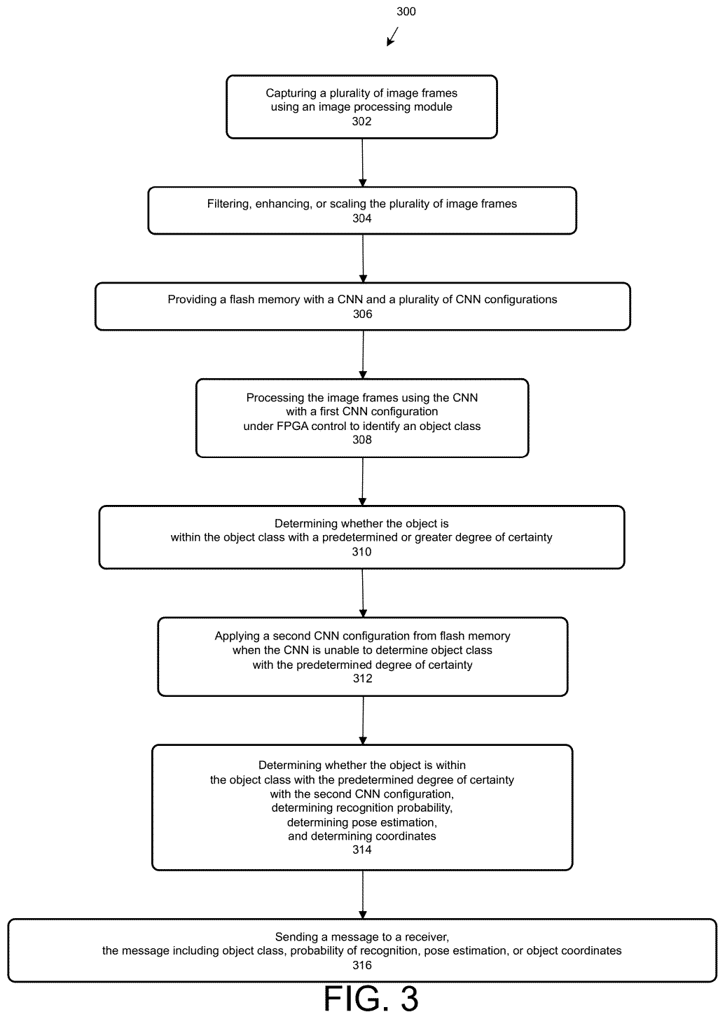

A series of operations 300 using the device of FIG. 1 is shown in FIG. 3. At 302, image frames of an object are captured using an image sensor, such as complementary metal oxide semiconductor (CMOS), charge-coupled device (CCD), long-wave infrared (LWIR), or short-wave infrared (SWIR) sensor, for example, an image sensor onboard an autonomous vehicle or an image sensor mounted in a fixed location. At 304, filtering, enhancing, or scaling the plurality of image frames using an image processing module takes place. A flash memory is provided at 306 with a convolutional neural network (CNN) and a plurality of configurations of the CNN. Each CNN configuration includes a set of weights and CNN parameters, which comprise: number of backbone convolutional layers, number of connections inside and between layers and number of input and output channels of every convolutional layer, such as shown in the exemplary tables of FIG. 2. Image frames are processed at 308, using the CNN with a first CNN configuration under the control of a Field-Programmable gate array (FPGA) control block to identify an object class. The FPGA control block adjusts CNN configurations according to a set of adjustment rules stored in the flash memory in the control registry. Determining whether the object is within the object class with a predetermined degree of certainty for a predetermined time period (t₁) takes place at 310.

When the CNN is unable to determine whether the object is within the object class with a predetermined or greater degree of certainty after period t₁ using the first CNN configuration, a second CNN configuration is applied from the flash memory at 312. The FPGA directs the CNN at 314 to determine whether the object is within the object class with a predetermined or greater degree of certainty using the second CNN configuration. At 316, a message is sent to a receiver. The message includes the object class, probability of recognition, pose estimation and coordinates of the object within the image determined by the CNN using the second CNN configuration.

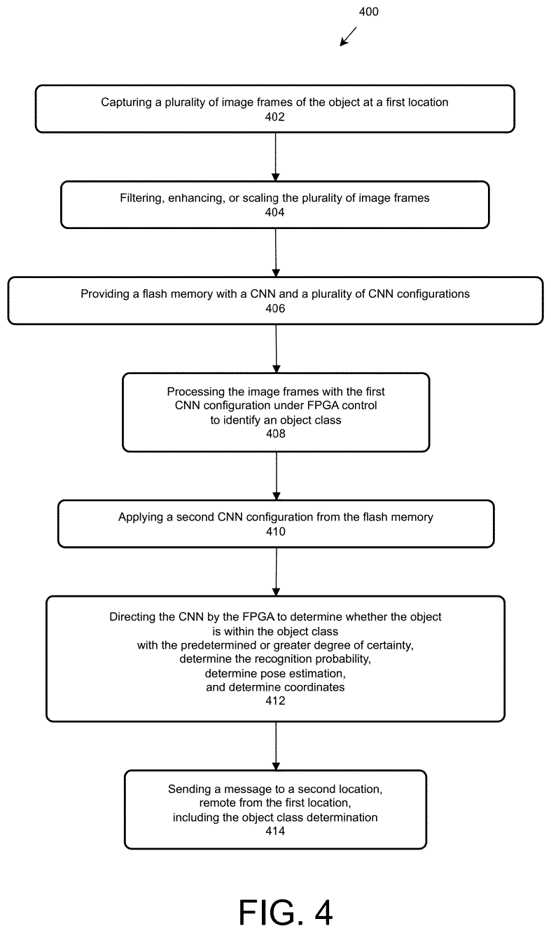

FIG. 4 shows an alternative series of operations. At 402, a plurality of image frames of an object are captured using an image sensor positioned at a first location. The first location can be a secure area or an area overlooking a roadway or traffic site of interest. Filtering, enhancing, or scaling the plurality of image frames takes place at 404 using an image processing module at the first location. A flash memory is provided at 406 with a convolutional neural network (CNN) and a plurality of configurations of the CNN at the first location. Each CNN configuration includes a set of weights and CNN parameters, wherein CNN parameters comprise number of layers, number of connections inside and between layers and number of input and output channels of every convolutional layer multipliers;

FIG. 2 shows exemplary samples of values that can be used for CNN configurations. For example, image frames can be processed at 408 using the CNN with a first CNN configuration under the control of a Field-Programmable gate array (FPGA) control block to identify an object class. The FPGA control block comprises a register for storing rules for adjusting CNN configurations. A determination is made whether the object is within the object class with a predetermined degree of certainty for a predetermined time period.

When the CNN is unable to determine whether the object is within the object class with a predetermined degree of certainty after a time period (t₁) using the first CNN configuration, a second CNN configuration is applied from the flash memory at 410. The CNN at 412 continues classification to determine whether the object is within the object class with a predetermined, greater degree of certainty using the second CNN configuration. A determination is also made about object class, probability of recognition, pose estimation and coordinates of the object within the image. At 416, a message is sent to a second location, remote from the first location. This message can include not only the object class, but also the probability of recognition, pose estimation, or coordinates of the object within the image determined by the CNN with the second CNN configuration.

In an exemplary embodiment, the device is installed at a location adjacent to a roadway with an angle for observing traffic. Alternatively, the device comprises a security camera installed with a view of an entrance to a building of interest.

In an embodiment, YOLO, or a similar computer vision model designed for real-time object detection, is used for image detection. An example of a suitable model for fast recognition of different object types is the YOLO (You Only Look Once) object detection model family. Models such as YOLO can identify and localize objects in images and videos, detecting a wide range of objects from common items like cars and people. Such models are optimized for speed, allowing them to detect objects in real-time with minimal latency. These fast object-detection models can also classify objects into specific categories, providing additional information about the detected objects. The fast object-detection model can also output masks that segment the detected objects, providing more detailed information about their shape and location.

For fast recognition of different types of objects, a network (the first CNN) starts by taking an image as input and parsing the image into a grid of cells. The backbone of the CNN starts searching for correlations between pre-trained images and the input image at a different scale allowing the CNN to recognize objects regardless of their size within the image. In this context, scale refers to the size of the entire object within the image. For example, the CNN can recognize a wheel at various scales, independent of whether it is part of a car or another context. Multiple scales help the CNN to reliably identify objects even when they appear at different sizes within the visual scene.

Next, a neck network preparing scaling results for a detection head. The detection head uses found correlations to generate predictions for each grid cell, including coordinates of the object (bounding box coordinates), class probabilities, and objectness scores. Finally, Non-Maximum Suppression (NMS) is employed to filter out redundant predictions, keeping only the most confident and accurate ones. The end result is a set of detected objects, class label, probability of recognition and as option coordinates of the object (bounding box coordinates), pose estimation.

A FPGA computer vision model, as described above, uses Convolutional Neural Networks (CNNs) as the foundational elements of its architecture. The backbone network, which can be based on architectures such as CSPDarknet53, constitutes a deep CNN responsible for searching correlation between the input image and pre-trained images. The backbone network comprises multiple convolutional layers, mixed with operations like pooling and normalization. This approach allows the model to efficiently correlate visual patterns at different scales, allowing object recognition based on overall size and context.

A neck network, also composed of convolutional layers, preparing scaling results for a detection head. The neck network aggregates information from diverse sizes of image, furnishing a comprehensive representation for object detection across different scales.

A detection head employs convolutional layers to process all the correlations that have been found earlier and generate predictions for each grid cell within the image. Convolutional layers are trained to identify objectness, classify objects by finding the most significant correlation with pretrained images, and accurately regress the coordinates of the object (bounding box coordinates). Objectness, in object-detection models, such as YOLO, helps distinguish meaningful object proposals from the vast number of potential regions in an image. By assigning an objectness score to each region, the model can prioritize regions with higher objectness for further processing and discard regions with low objectness, thereby improving both efficiency and accuracy.

An exemplary model, such as YOLO, employs residual connections (or skip connections) within its network. These connections allow the network to learn residual mappings (the difference between the input and output of a layer) which can help with training deeper networks and improve gradient flow.

In an embodiment, the onboard CNN uses a Residual Network (ResNet) architecture with 34 parameter layers, configured for image recognition tasks. In ResNet CNN architecture, shortcut connections are added to pairs of 3×3 convolutional filters, which transform the network into its residual version. Identity shortcuts can be applied directly when input and output have the same dimensions. When the dimensions increase, zero-padding can be used for increasing dimensions without introducing extra parameters or projection shortcuts can be used to match dimensions through 1×1 convolutions.

A primary characteristic of ResNet architecture is the use of residual learning, where the stacked layers are explicitly configured to fit a residual mapping. This approach addresses the degradation problem commonly encountered in deep neural networks, where accuracy saturates and then degrades rapidly as depth increases. By reformulating the layers as learning residual functions with reference to the layer inputs, the network becomes easier to optimize and can achieve accuracy gains from increased depth. For example, a 34-layer residual image network is used because of its superior performance compared to plain networks with the same number of backbone convolutional layers.

1. A device for capturing and classifying a digital image of an object, the device comprising:
a flash memory;
an image sensor configured for capturing a plurality of image frames of the object;
an image processing module configured to receive the plurality of image frames from the image sensor and to filter, enhance, or scale the plurality of image frames;
a convolutional neural network (CNN) with an adjustable configuration configured for processing the image frames and identifying an object class using a first configuration;
a plurality of CNN configurations stored in the flash memory, each CNN configuration comprising a set of weights and CNN parameters, wherein CNN parameters comprise number of layers, number of connections inside and between layers, and number of input and output channels of every convolutional layer;
an FPGA control block, operably connected to the flash memory, the image processing module, and the CNN, wherein the FPGA control block adjusts CNN configuration according to a set of adjustment rules stored in the flash memory in a control registry, the FPGA control block configured to:
direct the CNN to determine whether the object is within the object class with a predetermined or greater degree of certainty using the first CNN configuration for a predetermined time period t₁;
when the CNN is unable to determine whether the object is within the object class with the predetermined or greater degree of certainty after the predetermined time period t₁ using the first CNN configuration, adjusting the CNN in accordance with the stored control registry rules by applying a second CNN configuration from the flash memory and directing the CNN to determine whether the object is within the object class with the predetermined or greater degree of certainty, determine a probability of recognition, and determine a pose estimation and coordinates of the object within the image determined by the CNN using the second configuration of the CNN; and
a transmitter, configured to send a message to a receiver, the message comprising at least one of the following parameters: the object class, the probability of recognition, the pose estimation and the coordinates of the object within the image determined by the CNN.

2. The device of claim 1, wherein the message further comprises an image with an identified object class and a probability of detection.

3. The device of claim 1, wherein the predetermined degree of certainty corresponds to an uncertain determination that the object is within the object class.

4. The device of claim 1, wherein the FPGA control block is further configured to change CNN configurations and restore the first CNN configuration in accordance with the set of adjustment rules stored in flash memory in the control registry after the object is classified with the predetermined or greater degree of certainty using the second configuration.

5. The device of claim 1, wherein adjusting the configuration of the CNN includes one or more of modifying weights, a number of layers, a number of connections inside and between the layers, and a number of input and output channels of every convolutional layer.

6. A method of capturing and classifying a digital image of an object, the method comprising:
capturing a plurality of image frames of the object using an image sensor;
filtering, enhancing, or scaling the plurality of image frames using an image processing module;
providing a flash memory with a convolutional neural network (CNN) and a plurality of configurations of the CNN, each CNN configuration comprising a set of weights and CNN parameters, wherein CNN parameters comprise number of layers, number of connections inside and between layers, and number of input and output channels of the convolutional layer multipliers;
processing the image frames using the CNN with a first CNN configuration under the control of a Field-Programmable gate array (FPGA) control block to identify an object class, wherein the FPGA control block adjusts CNN configurations according to a set of adjustment rules stored in the flash memory in the control registry;
determining whether the object is within the object class with a predetermined or greater degree of certainty for a predetermined time period t₁;
when the CNN is unable to determine whether the object is within the object class with the predetermined or greater degree of certainty after the predetermined time period t₁ using the first CNN configuration, applying a second CNN configuration from the flash memory;
determining whether the object is within the object class with the predetermined or greater degree of certainty using the second CNN configuration, determining a probability of recognition, and determining a pose estimation and coordinates of the object within the image determined by the second CNN;
sending a message to a receiver, the message comprising at least one of the following parameters: the object class, probability of recognition, pose estimation and coordinates of the object within the image determined by the second CNN.

7. The method of claim 6, wherein the second CNN configuration is followed by a third CNN configuration over a time t₃, wherein time t₃ lasts until the CNN is able to determine whether the object is within the object class with the predetermined or greater degree of certainty.

8. The method of claim 6, wherein the predetermined degree of certainty corresponds to a determination that the object is within an object class.

9. The method of claim 6, wherein the FPGA control block is further configured to reapply the first CNN configuration after the object is classified with the predetermined or greater degree of certainty using the second CNN configuration.

10. A method of capturing and classifying a digital image of an object, the method comprising:
capturing a plurality of image frames of the object using an image sensor positioned at a first location;
filtering, enhancing, or scaling the plurality of image frames using an image processing module at the first location;
providing a flash memory with a convolutional neural network (CNN) and a plurality of configurations of the CNN at the first location, each CNN configuration comprising a set of weights and CNN parameters, wherein CNN parameters comprise number of layers, number of connections inside and between layers and number of input and output channels of every convolutional layer multipliers;
processing the image frames using the CNN with a first CNN configuration under the control of a Field-Programmable gate array (FPGA) control block to identify an object class, wherein the FPGA control block adjusts CNN configurations according to a set of adjustment rules stored in the flash memory in a control registry;
determining whether the object is within the object class with a predetermined or greater degree of certainty for a predetermined time period t₁;
when the CNN is unable to determine whether the object is within the object class with the predetermined or greater degree of certainty after the predetermined time period t₁ using the first CNN configuration, applying a second CNN configuration from the flash memory;
directing, by the FPGA, the CNN to determine whether the object is within the object class with the predetermined or greater degree of certainty using the second CNN configuration, to determine a probability of recognition, and to determine a pose estimation and coordinates of the object within the image determined by the second CNN; and
sending a message to a second location, remote from the first location, the message comprising the object class determined by the second CNN.

11. The method of claim 10, wherein the second CNN configuration is followed by a third CNN configuration over a time t₃, wherein time t₃ lasts until the CNN is able to determine whether the object is within the object class with the predetermined or greater degree of certainty.

12. The method of claim 10, wherein the FPGA control block is further configured to apply a plurality of CNN configurations with different system requirements and further configured to adjust CNN configurations based on available system resources.

13. The method of claim 10, wherein the FPGA control block is further configured to change CNN configurations and to re-apply the first CNN configuration after the object is classified with predetermined or greater certainty using the second CNN configuration.

14. The method of claim 10, wherein the predetermined degree of certainty corresponds to a determination that the object is within an object class.

15. The method of claim 13, wherein the third CNN configuration is removed before the second CNN configuration.

16. The method of claim 10, wherein the control registry comprises rules for object processing based on environmental conditions at the first location.

17. The method of claim 10, wherein the message further comprises the probability of recognition, the pose estimation and the coordinates of the object within the image determined by the second CNN.

18. The method of claim 10, wherein the FPGA controls the execution of a plurality of tasks with a plurality of urgencies and the predetermined degree of certainty is adjusted dynamically based on the urgency of execution of one of the plurality of tasks.

19. The method of claim 10, wherein the second location is in communication with the first location by a communications network.

20. The method of claim 10, wherein the image sensor is mounted in a fixed position at the first location.
